(19) United States
(12) Patent Application Publication
(10) Pub. No.: US 2024/0308145 A1
(43) Pub. Date: Sep. 19, 2024

(54) METHOD OF MANUFACTURING BONDED BODY OF DIFFERENT MATERIALS, AND BONDED BODY OF DIFFERENT MATERIALS

(71) Applicant: Mitsubishi Electric Corporation, Tokyo (JP)

(72) Inventor: Tatsuya KITAGAWA, Tokyo (JP)

(21) Appl. No.: 18/277,797

(22) PCT Filed: Mar. 10, 2021
(86) PCT No.: PCT/JP2021/009568

§ 371 Date: Aug. 18, 2023

(51) Int. Cl. B29C 65/00; B29K 61/00; B32B 15/08; B32B 17/10

(52) U.S. Cl. CPC B29C 65/002; B29C 66/742; B29C 66/7465; B32B 15/08; B32B 17/10; B29K 2061/00

(57) ABSTRACT

A manufacturing method for a bonded body of different materials includes a coating process of coating a surface of a base material of an inorganic material including metal or glass with a coupling agent solution, an irradiation process of forming a binding layer in which the base material and coupling agent molecules in the coupling agent solution are bonded through covalent bond by irradiating the surface of the base material coated with the coupling agent solution with a laser while a position of the laser is sequentially changed, a cleaning process of cleaning the coupling agent solution that is not covalently bonded to the base material, and a resin bonding process of bonding the binding layer and a resin.

### TECHNICAL FIELD

This disclosure relates to a method of manufacturing a bonded body in which a metal member or a glass member is bonded to a resin member, and the bonded body.

### BACKGROUND ART

A conventional method of bonding an inorganic material such as a metal or a glass to an organic compound such as a resin via a primer has been known. For example, a method is disclosed (Patent Document 1) in which a silane coupling agent as a primer is applied to a metal surface, dried, and then bonded to a resin.

### CITATION LIST

### Patent Document

Patent Document 1: Japanese Patent Application Laid-Open No. 2018-39211

### SUMMARY OF INVENTION

### Problems to be Solved by Invention

In a conventional method of manufacturing a bonded body, it is necessary to heat the bonded body at a high temperature in a drying furnace for a long period of time, and thus there has been a problem that it takes time to manufacture the bonded body.

The present disclosure is made to solve the above-described problem, and an object thereof is to manufacture, in a short time, a bonded body in which an inorganic material including a metal member or a glass member is bonded to a resin member.

### Means for Solving Problems

Provided in one claim in the present disclosure includes a coating process of coating a surface of an inorganic base material including metal or glass with a coupling agent solution, an irradiation process of forming covalent bond between a base material and adsorbed coupling agent molecules of the coupling agent solution by irradiating a surface coated with the coupling agent solution with a laser while a position of the laser is sequentially changed, a cleaning process of cleaning the coupling agent molecules that are not covalently bonded to the base material, and a resin bonding process of bonding the coupling agent molecules covalently bonded to the base material, and a resin.

### Advantageous Effect of Invention

According to the present disclosure, a bonded body of different materials in which a resin member and a member made of an inorganic substance including metal or glass are bonded can be manufactured in a short time.

### BRIEF DESCRIPTION OF THE DRAWINGS

FIG. 1 is an illustrative diagram of a manufacturing method for a bonded body of different materials according to Embodiment 1 of the present disclosure.

FIG. 2 is an illustrative diagram of a binding layer on a base material according to Embodiment 1 of the present disclosure.

FIG. 3 is an illustrative diagram of an example of a manufacturing method for the bonded body of different materials according to the present disclosure.

FIG. 4 is a graph showing a relationship between laser irradiation conditions and shear strength according to Embodiment 1 of the present disclosure.

FIG. 5 is a diagram showing a surface state of the binding layer depending on the laser irradiation conditions according to Embodiment 1 of the present disclosure.

FIG. 6 is an illustrative diagram of a manufacturing method for a bonded body of different materials according to Embodiment 2 of the present disclosure.

FIG. 7 is a diagram showing an example of a binding layer on a base material according to Embodiment 2 of the present disclosure.

FIG. 8 is a diagram showing another example of the binding layer on the base material according to Embodiment 2 of the present disclosure.

FIG. 9 is a diagram showing another example of the binding layer on the base material according to Embodiment 2 of the present disclosure.

### MODE FOR CARRYING OUT INVENTION

Hereinafter, embodiments of the present disclosure will be described with reference to the drawings. However, the present invention is not limited to the embodiments described below and can be combined and modified as appropriate. In addition, the drawings are simplified for easy understanding of the explanation as appropriate.

### Embodiment 1

A method of manufacturing a bonded body of different materials according to the present embodiment includes: a coating process of coating a surface of an inorganic base material including metal or glass with a coupling agent solution; an irradiation process of forming a binding layer in which the base material and coupling agent molecules in the coupling agent solution adsorbed to the base material are bonded by covalent bond by irradiating, with a laser, the surface of the base material coated with the coupling agent solution while a position of the laser is sequentially changed; a cleaning process of cleaning the coupling agent molecules not covalently bonded to the base material; and a resin bonding process of bonding the binding layer covalently bonded to the base material and a resin.

More specifically, the coupling agent solution is, for example, a silane coupling agent solution, a titanate-based coupling agent solution, or an aluminate-based coupling agent solution, and in the irradiation process, a pulse laser is radiated onto the surface of the base material coated with the coupling solution while the position of the laser is sequentially changed to form the binding layer in which the base material and the adsorbed coupling agent molecules are bonded by the covalent bond. In addition, since the coupling agent molecules that have not formed the covalent bond in the irradiation process are cleaned and removed in the cleaning process, unnecessary coupling agent molecules do not remain after the cleaning process. After that, in the resin bonding process, the base material and the resin are bonded via the binding layer in which the coupling molecules are covalently bonded to the base material.

In the manufacturing method for the bonded body of different materials according to the present disclosure, because the pulse laser is used to form the binding layer by covalently bonding the base material and the coupling agent solution, there is no damage to the coupling agent molecules coated on the base material, and the binding layer that is covalently bonded at a desired position irradiated with the pulse laser can be obtained.

In addition, when the pulse laser irradiation condition is set within an appropriate energy amount range, a more uniform and better binding layer can be obtained. That is, by the irradiation of the energy within the above range, the molecular chains of the coupling agent molecules forming the binding layer are not broken, and the deterioration of the properties of the binding layer can be avoided. An appropriate energy amount for the pulse laser irradiation is such that the irradiation energy density ranges from 1 J/cm² to 10 J/cm².

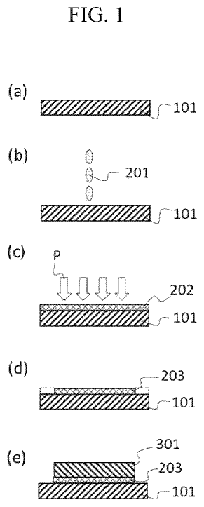

Next, a manufacturing method for the bonded body of different materials according to the present embodiment will be described using FIG. 1. FIG. 1 is a cross-sectional view of the bonded body of different materials in the longitudinal direction (the surface perpendicular to the surface coated with the coupling agent solution). FIG. 1 (a) is a longitudinal cross-sectional view of a base material 101 of an inorganic material including metal or glass; FIG. 1 (b) shows a coating process for coating the base material 101 with a coupling agent solution 201; FIG. 1 (c) shows an irradiation process for forming a binding layer 203 in which the base material 101 and adsorbed coupling agent molecules 202 are covalently bonded by irradiating, with a laser, the coupling agent molecules 202 in the coupling agent solution 201 being adsorbed on the base material 101; FIG. 1 (d) shows a cleaning process for cleaning the adsorbed coupling agent molecules 202 that are not covalently bonded to the base material 101; and FIG. 1 (e) shows a resin bonding process for bonding the binding layer 203 and a resin 301. Each process will be described below.

In FIG. 1, first, the base material 101 is prepared. The base material 101 made of the inorganic material containing metal or glass is not particularly limited, and examples thereof include metals such as Fe, Ni, Co, Cr, Mn, Zn, Pt, Au, Ag, Cu, Pd, Al, W, Ti, V, Mo, Nb, Zr, Pr, Nd, and Sm or an alloy containing these metals, or a glass-based material such as silicate glass (quartz glass), alkali silicate glass, soda lime glass, potash lime glass, lead (alkali) glass, barium glass, or borosilicate glass; and a composite material in which one kind or two or more kinds of these materials are combined. The base material 101 of such an inorganic material may be any material that can form the covalent bond with the coupling agent molecules 202.

In addition, the base material 101 may be a material in which a plating process such as Ni plating or Cu plating or stabilization treatment such as chromate treatment or alumite treatment is performed on the surface of the base material 101. Furthermore, it is preferable that the surface of the base material 101 is subjected to pretreatment such as plasma treatment, corona treatment, and ultraviolet irradiation treatment. By performing such pretreatment, the bonding surface can be cleaned and activated, so that the wettability of the coupling agent solution 201, which will be described later, can be improved and a uniform treated surface can be obtained.

Next, the coating process shown in FIG. 1 (b) will be described. In the figure, the coupling agent solution 201 is coated on the surface of the base material 101. The coupling agent solution 201 is, what we call, a solution in which a coupling agent is diluted with a solvent so as to be easily coated on the surface of the base material 101. As the coupling agent, a silane coupling agent is preferable. The silane coupling agent has, at one end of the molecule, a functional group that can interact with or chemically react with the resin 301 (described in detail later), and has, at the other end of the molecule, a hydrolyzable group (Si—OR (where R is a molecule composed of carbon and hydrogen)). The hydrolyzable group reacts with water in the solvent or moisture in the environment (air) to become a silanol group (Si—OH), thereby enabling interaction or chemical reaction with the base material 101.

The functional group is preferably an epoxy group, a mercapto group, an isocyanate group, or the like, and more preferably an amino group. The amino group may include either an aliphatic amino group or an aromatic amino group.

The silane coupling agent solution is a solution in which a silane coupling agent is diluted with a solvent, and may contain one or more kinds of optional solvent components as necessary. The solvent for the silane coupling agent solution is not particularly limited as long as the silane coupling agent can be dissolved therein, but an organic solvent, water, a mixed solvent of water and alcohol, or the like is preferable. In the case of the silane coupling agent having the amino group as the functional group, a mixed solvent of water and ethanol is more preferable, which can improve the wettability of the inorganic material to the base material 101.

The hydrolyzable group (Si—OR) of the silane coupling agent is hydrolyzed by water in the solvent or moisture in the environment to become a silanol group (Si—OH). The silanol group can be adsorbed to the functional group such as a hydroxyl group existing on the surface of the base material 101. After that, by applying energy, the covalent bond is formed through a dehydration reaction, so that a strong binding layer 203 can be obtained. Here, a laser is used for the energy to be applied.

Here, the covalent bond is a very strong chemical bond formed by sharing electrons between atoms. Explanation will be made by taking a metal base material (M) and a silane coupling agent as an example. The surface of the metal is naturally oxidized and the hydroxyl group (OH) exists thereon in its bonded state (M-OH). Therefore, it can be adsorbed to the silanol group (Si—OH) of the silane coupling agent molecules 202 by hydrogen bonding. When energy such as thermal energy is applied in a state where these are adsorbed, a dehydration reaction occurs from each of the hydroxyl groups (OH), and as a result, the covalent bond of (M-OH—Si) is formed between a metal base material 101 (M) and the adsorbed silane coupling agent molecules 202. In this way, the binding layer 203 is formed in which the base material and the silane coupling agent molecules are bonded via the covalent bond.

In a case where the functional group on the other side (the side different from the silanol group) of the silane coupling agent molecules constituting the binding layer 203 includes the amino group (NH₂), when thermal energy or the like is applied, if the resin 301 is an epoxy resin, a condensation reaction occurs between the amino group and the epoxy ring in the epoxy resin, so that bonding also occurs via the covalent bond.

The method of coating the substrate 101 with the coupling agent solution 201 is not particularly limited, and examples thereof include a dipping method, a spin coating method, a bar coating method, a spray coating method, and a screen printing method.

It is desirable that the concentration of the coupling agent in the coupling agent solution 201 for the coating is in the range of 0.1 to 10 v/v %. When the concentration is 0 1 v/v % or less, the adsorption amount of the coupling agent molecules 202 to the base material 101 is insufficient and unevenness thereof occurs. On the other hand, when the concentration is 10 v/v % or more, the coupling agent molecules 202 are overlapped and adsorbed to the base material 101, so that the adsorbed coupling agent molecules 202 that do not contribute to the formation of the covalent bond with the surface of the base material 101 are present in a large amount, thereby reducing the strength of the binding layer 203 itself. Here, v/v % is a ratio (volume percentage concentration) of the volume (v) of the coupling agent to the volume (v) of the solvent.

As described above, the substrate 101 is coated with the coupling agent solution 201 and the coupling agent molecules 202 are uniformly adsorbed to the base material 101 at an appropriate density.

Next, the irradiation process of FIG. 1(c) will be described. As shown in the figure, the coupling agent molecules 202 adsorbed on the base material 101 are irradiated with a laser to form the binding layer 203 in which the base material 101 and the coupling agent molecules 202 are covalently bonded.

The coupling agent molecules 202 adsorbed on the base material 101 in the coating process is irradiated at a desired position with laser energy, so that the base material 101 and the coupling agent molecules 202 at the position are firmly fixed. Any portion of the base material 101 is selectively irradiated with the laser to apply energy thereto. That is, by irradiating the necessary portion with the laser, the adsorbed coupling agent molecules 202 react with the surface of the base material 101 to form the covalent bond, so that the portion of the adsorbed coupling agent molecules 202 irradiated with the laser is firmly fixed to the base material 101.

The laser with which the coupling agent molecules 202 adsorbed on the base material 101 are irradiated may be a continuous wave laser (CW) or the pulse laser, but the pulse laser is preferable. When the energy irradiation is performed using the pulse laser, the damage due to the heat of the irradiated portion can be suppressed, so that the deterioration, the change in quality, and the breakage of the adsorbed coupling agent molecules 202 can be prevented.

In addition, it is preferable that the pulse width of the pulse laser is as short as possible in order to suppress the influence of heat. To be more specific, it is preferable that the pulse width is 10 ns (nanosecond) or less. Further, 1 ps (picosecond) or 1 fs (femtosecond) is preferable. On the other hand, as the pulse width is smaller, the facility cost becomes much higher; therefore, considering the producibility, it is suitable to use a pulse width on the order of 10 ns.

The wavelength of the pulse laser is not particularly limited, but is preferably in the range of, for example, 200 to 1500 nm, and more preferably in the range of 400 to 1000 nm. The average power of the pulse laser is also not particularly limited, but is preferably about 0.1 to 100 W, and more preferably about 1 to 25 W. If the output is higher than this, damage to the base material 101 is concerned.

The energy density (J/cm²) of the pulse laser in the radiation per unit area is preferably in the range of 0.5 to 20 J/cm². Further, the range of 1 to 10 J/cm² is more preferable. In the case of less than 0.5 J/cm², the amount of energy to be supplied is small, so that the adsorbed coupling agent molecules 202 cannot react with the substrate 101. On the other hand, in the case of 20 J/cm² or more, the energy to be supplied is excessive, so that the adsorbed coupling agent molecules 202 themselves are deteriorated, changed in quality, or damaged.

Next, in FIG. 1(d), after the laser irradiation described above, the unreacted and adsorbed coupling agent molecules 202 existing on the base material 101 in the laser non-irradiated portion are removed. The removal method is not particularly limited, and a method such as cleaning with the same solvent as that for the coupling agent solution or ultrasonic cleaning is used. In addition, at this time, in the binding layer 203 irradiated with the pulse laser, the coupling agent molecules 202 that have been adsorbed in an excessively overlapping manner and have not reacted with the base material 101 can also be removed at the same time.

Next, in FIG. 1(e), the base material 101 and the resin 301 are bonded together via the binding layer 203, whereby the bonding of the base material 101 and the resin 301 is completed. As the resin 301 used here, a thermosetting resin is preferable, and an epoxy resin is more preferable. This is because a strong bond can be formed by the reaction or interaction between the functional group of the epoxy resin and the functional group of the coupling agent molecules 202.

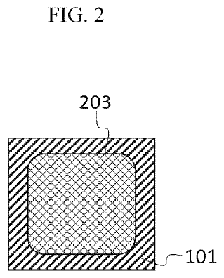

FIG. 2 is a diagram showing the base material 101 on which the binding layer 203 is formed in the laser irradiation process, viewed from the upper side of the coating surface of the coupling agent solution 201. As shown in the figure, since the binding layer 203 is formed by the irradiation of the pulse laser, the bonding layer can be formed not only in the same shape as the surface of the base material 101 but also in any shape different from the surface of the base material 101. FIG. 2 shows an example in which the binding layer 203 is smaller than the surface of the base material 101 and the corners thereof are rounded.

The adsorbed coupling agent molecules 202 form the binding layer 203 in a short time by the laser irradiation on the base material 101, and the binding layer 203 reacts or interacts with both the base material 101 and the resin 301, so that the bonding property therebetween can be improved.

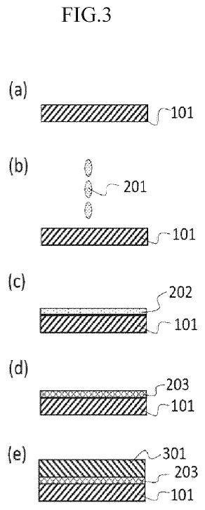

Next, referring to FIG. 3, another example of the flow of the silane coupling agent treatment by heat treatment will be described.

In FIG. 3(a), the base material 101 is prepared. As in FIG. 1 (a), the base material is not particularly limited. In addition, as pretreatment of the base material surface, pretreatment such as plasma treatment, corona treatment, or ultraviolet irradiation treatment is preferably performed.

Next, in FIG. 3(b), the surface of the base material 101 is coated with the silane coupling agent solution 201. The coating method is not particularly limited, and examples thereof include a dipping method, a spin coating method, a bar coating method, a spray coating method, and a screen printing method. At this time, the concentration of the silane coupling agent solution 201 is not particularly limited, but it is typical to use it at 0.1 to 10 v/v %.

Thereafter, if necessary, the excessively adsorbed silane coupling agent solution 201 is removed by a method such as washing with water to obtain the base material 101 coated with the silane coupling agent molecules 202 adsorbed to a desired thickness as shown in FIG. 3(c).

Next, in FIG. 3(d), the binding layer 203 of the silane coupling agent immobilized on the base material 101 can be obtained by performing heat treatment in a drying furnace. Although the condition for the heat treatment is not limited, it is generally desirable to heat them at a temperature equal to or higher than the temperature at which the solvent volatilizes. For example, in the case of a water solvent, it is preferable that the temperature is 100 degrees C. or higher and 250 degrees C. or lower at which the silane coupling agent molecules 202 are not decomposed. The drying time is also not limited, but is preferably 30 seconds or more and 60 minutes or less. More preferably, the heat treatment is performed at at least 150 degrees C. and at most 200 degrees C. for at least 15 minutes and at most 30 minutes. In the process of FIG. 3(d), heat treatment at a high temperature for a long time is generally required, so that the productivity is lowered.

As described above, the adsorbed silane coupling agent molecules 202 are immobilized on the base material 101, and the binding layer 203 of the silane coupling agent immobilized on the surface is formed.

Next, in FIG. 3(e), the base material 101 is bonded to the resin 301 via the binding layer 203 of the silane coupling agent molecules immobilized on the base material 101. The resin 301 is cured by heating, and, at the same time, reacts with the binding layer 203 of the immobilized silane coupling agent, so that the bonding to the base material 101 is completed. Although the resin 301 to be used is not limited, an epoxy resin can be cured and bonded at 175 degrees C.

Next, specific examples of the present disclosure will be described. Hereinafter, explanation corresponding to the manufacturing method for the bonded body of different materials shown in FIG. 1 will be made. As the base material 101 shown in FIG. 1(a), an aluminum A5052 was used in which the surfaces of the base material 101 were degreased with acetone.

As the coupling agent solution 201 shown in FIG. 1 (b), an amino-based silane coupling agent, to be more specific, KBM603 manufactured by Shin-Etsu Chemical Co., Ltd., was prepared to be a 10 v/v % aqueous solution. In the process shown in FIG. 1(b), after the base material 101 is dip-coated with the coupling agent solution 201 being a 10 v/v % aq. solution of the amino-based silane coupling agent, excessive liquid is removed by air blow to form the adsorbed thin film coupling agent molecules 202.

In the process of FIG. 1(c), the pulse laser P is radiated to the adsorbed silane coupling agent molecules 202 that are composed of the amino group-based silane coupling agent aqueous solution serving as the coupling agent solution 201. As the pulse laser P, MX-Z2000H (wavelength 1,062 nm) manufactured by Omron Corporation is used. When the pulse laser P is radiated, the frequency and the speed are adjusted so that the irradiated pulse spots are adjacently and continuously arranged, and the energy densities of the pulse laser P radiated were varied between 0.5 and 15 J/cm². The portion to be left as the silane coupling agent molecules 202 is irradiated with the pulse laser P, and in the irradiated portion, the binding layer 203 is obtained in which the adsorbed silane coupling agent molecules 202 are bonded to the base material 101.

In the process of FIG. 1(d), the base material 101 on which the binding layer 203 has been formed by the laser irradiation is cleaned in running water for 60 seconds to remove the silane coupling agent molecules 202 that have not constituted the binding layer 203. By the cleaning process, the base material 101 shown in FIG. 1(d) is obtained in which the binding layer 203 of the silane coupling agent is formed on the portion irradiated with the laser.

In the process shown in FIG. 1(e), a liquid epoxy resin (for example, manufactured by Ryoden Kasei Co., Ltd.) is potted on the binding layer 203 of the silane coupling agent obtained as described above, and heated at 180 degrees C. to be cured, so that the epoxy resin 301 is bonded to the base material 101 via the binding layer 203 of the silane coupling agent (FIG. 1(e)).

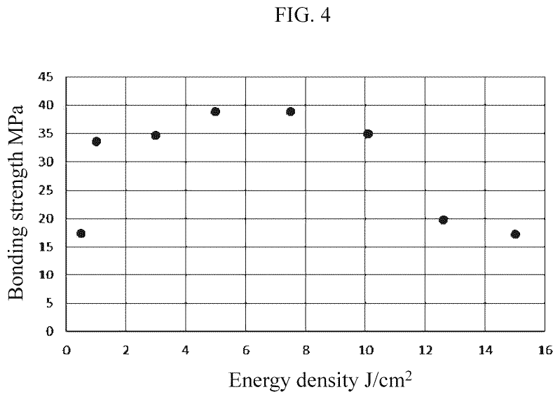

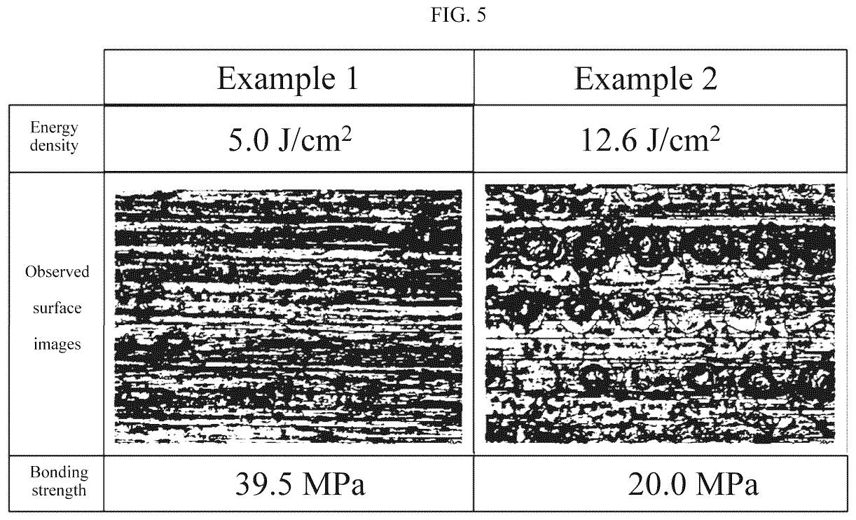

Next, the measurement results of the bonded bodies obtained above will be shown. FIG. 4 shows the measurement results of the bonding strength obtained by performing a shear test at a speed of 10 mm/sec on the bonded body obtained above. Further, representative appearance images are shown in FIG. 5. As shown in the figure, in Example 1 in which the laser was radiated at an energy density of 5.0 J/cm², no damage was observed on the surface. In contrast, in Example 2 in which the laser was radiated at an energy density of 12.6 J/cm², pulse marks were observed on the front surface, and peeling of the binding layer 203 of the silane coupling agent was observed. As described above, in Example 1 in which the pulse laser having an energy density of 1 to 10 J/cm² is used for the irradiation, the bonding can be made via the covalent bond without damaging the binding layer 203, so that a sufficiently high bonding strength can be obtained. In contrast, in Example 2 in which pulse laser irradiation at 12.6 J/cm² of 10 J/cm² was performed, peeling of the binding layer was observed and the binding layer 203 was partially broken, so that the bonding strength was considered to be decreased. From the above, it can be seen that the energy application results of the pulse laser in the energy density range of 1 to 10 J/cm² are good. When the bonding strength of the bonded body obtained as described above was measured, the bonding strength was 30 to 40 MPa.

Next, explanation corresponding to an example of a manufacturing method for the bonded body of different materials shown in FIG. 3 will be made. The base material 101 shown in FIG. 3 (a) and FIG. 3(b) and the silane coupling agent solution 201 are prepared under the same conditions as those described above in Embodiment 1, and the base material 101 is coated with the silane coupling agent solution 201 by a dipping method in FIG. 3 (b).

In the process of FIG. 3(c), the excessive coupling agent solution 201 (10 v/v % aqueous solution of amino group-based silane coupling agent) is removed by washing with water, so that the base material 101 on which the silane coupling agent molecules 202 are adsorbed is obtained.

In the process of FIG. 3(d), the base material 101 with the silane coupling agent molecules 202 adsorbed thereon, which is obtained in the process of FIG. 3 (c), is heat-treated at 180 degrees C. for 30 minutes. By this heat treatment, the base material 101 on which the binding layer 203 is formed is obtained.

In the process of FIG. 3 (e), as described in Embodiment 1, a liquid epoxy resin (manufactured by Ryoden Chemical Co., Ltd.) is potted on the binding layer 203 and heated to cure at 180 degrees C., so that the epoxy resin is bonded to the base material 101 via the silane coupling agent.

When the bonding strength of the bonded body obtained as described above was measured, the bonding strength was 30 to 40 MPa.

According to the present embodiment, since the irradiation process is included in which the surface on which the coupling agent solution 201 is coated is irradiated with the laser while the position thereof is sequentially changed to form the covalent bond between the base material 101 and the adsorbed coupling agent molecules 202 in the coupling agent solution 201, the bonded body in which the inorganic material including the metal member or the glass member and the resin member are bonded can be obtained in a short time.

In addition, according to the embodiment, since the binding layer 203 is formed by forming the covalent bond between the base material 101 and the adsorbed coupling agent molecules 202 by the laser irradiation, the thermal influence on the base material 101 is extremely small. Furthermore, since the covalent bond is formed by the laser irradiation to a desirable portion to be bonded to the resin, it is possible to improve the bonding strength only at a necessary portion of the bonded body such as a stress generating portion.

### Embodiment 2

In Embodiment 1 above, different materials are bonded together using a single type of coupling agent, however, in the present embodiment, explanation will be made about a bonded body of different materials in which different materials are bonded together by providing, in different regions of a base material, binding layers with coupling agents having different properties, and a manufacturing method therefor. Note that, unless otherwise specified, the same reference numerals and the same terms are used as those in the above-described embodiment.

A manufacturing method for a bonded body of different materials according to the present embodiment includes a coating process of coating a surface of a base material made of an inorganic material including metal or glass with a coupling agent solution, an irradiation process of forming a binding layer formed by the covalent bond between the base material and coupling agent molecules by irradiating, with a laser, the surface of the base material coated with the coupling agent molecules in the coupling agent solution, while the position of the laser is sequentially changed, a cleaning process of cleaning the coupling agent molecules that are not covalently bonded to the base material, and a resin bonding process of bonding the binding layer covalently bonded to the base material, and a resin. Here, the coating process includes a first coating process of coating with a first coupling agent solution, the irradiation process includes a first irradiation process of irradiating a partial region of the base material surface with a pulse laser, the cleaning process includes, after the first irradiation process, a first cleaning process of cleaning the coupling agent molecules that are not bonded to the base material, the coating process includes, after the first cleaning process, a second coating process of coating with a second coupling agent solution of a type different from the first coupling agent solution, and the irradiation process includes, after the second coating process, a second irradiation process of irradiating with the laser, a region of the base material surface different from the partial region of the surface irradiated in the first irradiation process.

Here, similar to Embodiment 1, the coupling agent solution is, for example, an amino-based silane coupling agent solution, and in the irradiation process, the pulse laser is radiated onto the base material surface coated with the coupling agent solution, while the position of the laser is sequentially changed, to form the binding layer bonded via the covalent bond. In addition, since the coupling agent molecules that have not formed the covalent bond in the irradiation process are cleaned and removed in the cleaning process, no excessive coupling agent molecules remain after the cleaning process. After that, in the resin bonding process, the base material and the resin are bonded via the binding layer in which the base material and the coupling agent molecules are covalently bonded.

Further, in the present embodiment, the method includes a coating process in which the surface of the base material is divided into multiple regions and each of the regions is coated with a different coupling agent solution, an irradiation process in which the pulse laser is radiated to form the binding layer formed by the covalent bond, and a cleaning process in which the coupling agent aqueous solution that has not formed the binding layer is removed.

In the manufacturing method for the bonded body of different materials according to the present embodiment, since the binding layer in which the base material and the coupling agent molecules are bonded by the covalent bond is formed using the pulse laser, there is no damage to the coupling agent molecules with which the base material is coated, and the binding layer in which the covalent bond is formed at a desired position can be obtained. In addition, since a different coupling agent solution is used for each region, a binding layer having a different characteristic for each region can be provided.

The bonded body of different materials according to the present embodiment includes the base material made of metal or glass, the bonding layer (primer portion) including a first binding layer in which first coupling agent molecules are covalently bonded to the surface of the base material, and the resin bonded to the surface opposite to the surface of the bonding layer (primer portion) that is covalently bonded to the base material. The bonding layer (primer portion) includes a first region in which the first binding layer is provided on the base material, and a second region in which a second binding layer is provided on the base material, the second binding layer being covalently bonded with second coupling agent molecules different from the first coupling agent molecules.

In the bonded body of different materials, the first binding layer formed in the first region and the second binding layer formed in the second region may have different elastic moduli. Furthermore, in the bonded body of different materials, the first region may be provided outside the second region, and the elastic modulus of the first binding layer formed in the first region may be higher than the elastic modulus of the second binding layer formed in the second region.

With such a configuration, the elastic modulus of the bonding layer (primer portion) on the outer side in the bonded body of different materials is made lower than that on the inner side, so that deformation in the outer side, which is more likely to be affected by thermal stress, can be allowed.

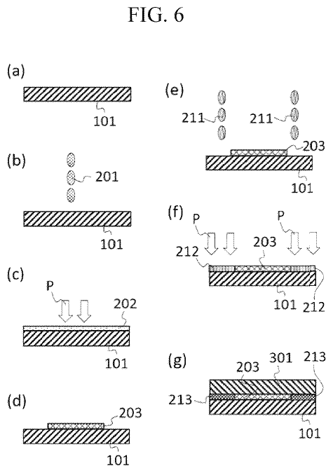

FIG. 6 is a diagram to illustrate the bonding method according to the present embodiment. FIG. 6 is a longitudinal cross-sectional view of the bonded body of different materials according to the present embodiment. In FIG. 6(a), first, the base material 101 is prepared. Similar to the above-described embodiment, the base material 101 made of the inorganic material including metal or glass is not particularly limited, and examples thereof include metals such as Fe, Ni, Co, Cr, Mn, Zn, Pt, Au, Ag, Cu, Pd, Al, W, Ti, V, Mo, Nb, Zr, Pr, Nd, and Sm or an alloy containing these metals, or a glass-based material such as silicate glass (quartz glass), alkali silicate glass, soda lime glass, potash lime glass, lead (alkali) glass, barium glass, or borosilicate glass, or a composite material in which one kind or two or more kinds of these materials are combined. The base material 101 of such an inorganic material may be any material that can form the covalent bond with the coupling agent molecules 202.

Further, similar to the above-described embodiment, the base material 101 may be a material in which a plating process such as Ni plating or Cu plating, or stabilization treatment such as chromate treatment or alumite treatment is performed on the surface of the base material 101. Furthermore, it is preferable that the surface of the base material 101 is subjected to pretreatment such as plasma treatment, corona treatment, and ultraviolet irradiation treatment. By performing such pretreatment, the bonding surface can be cleaned and activated, so that the wettability of the silane coupling agent solution 201, which will be described later, can be improved and a uniform treated surface can be obtained.

Next, in FIG. 6 (b), the surface of the base material 101 is coated with the coupling agent solution 201. As described in the explanation on FIG. 1 (b), the coupling agent solution 201 is, what we call, a solution in which a coupling agent is diluted with a solvent so as to easily coat the surface of the base material 101. As the coupling agent, the silane coupling agent is preferable. The silane coupling agent has, at one end of the molecule, a functional group that can interact with or chemically react with the resin 301, and has, at the other end thereof, a hydrolyzable group, as in the description on FIG. 1 (b).

The functional group is preferably an epoxy group, a mercapto group, an isocyanate group, or the like, and preferably an amino group. The amino group may include either an aliphatic amino group or an aromatic amino group.

The coupling agent solution 201 is, for example, a solution in which the silane coupling agent is diluted with a solvent and may contain one or more kinds of optional solvent components as necessary. The solvent for the coupling agent solution 201 is not particularly limited as long as the silane coupling agent can be dissolved therein, however, an organic solvent, water alone, a mixed solvent of water and alcohol, or the like is preferable. For example, in the case of the amino-based silane coupling agent, a mixed solvent of water and ethanol is more preferable, which can improve the wettability to the base material 101.

The hydrolyzable group is hydrolyzed by water in the solvent or moisture in the environment to become, for example, the silanol group in the case of the silane coupling agent solution. The silanol group can be adsorbed to the functional group such as a hydroxyl group existing on the surface of the base material 101. After that, by applying energy, the covalent bond is formed through a dehydration reaction, so that the strong binding layer 203 can be obtained. Here, a laser is used for the energy to be applied.

The method of coating the substrate 101 with the coupling agent solution 201 is not particularly limited, and examples thereof include a dipping method, a spin coating method, a bar coating method, a spray coating method, and a screen printing method.

The concentration of the coupling solution 201 for the coating is preferably in the range of 0.1 to 10 v/v %. When the concentration is 0.1 v/v % or less, the adsorption amount of the coupling agent molecules 202 to the base material 101 is insufficient and unevenness occurs. On the other hand, when the concentration is equal to or higher than 10 v/v %, the coupling agent is overlappingly adsorbed to the base material 101, so that there exist many adsorbed coupling agent molecules 202 that do not contribute to the formation of the covalent bond with the base material 101 surface, thereby reducing the strength of the binding layer 203 itself.

As described above, the substrate 101 is coated with the coupling agent solution 201, and the coupling agent molecules 202 are uniformly adsorbed to the base material 101 at an appropriate density.

Next, in FIG. 6(c), energy of the pulse laser P is radiated to the coupling agent molecules 202 adsorbed on the base material 101, so that the base material 101 and the coupling agent molecules 202 are firmly immobilized at desired positions. The coupling agent molecules 202 on the base material 101 is irradiated with the laser to form the binding layer 203 in which the base material 101 and the coupling agent molecules 202 are covalently bonded.

In the present embodiment, energy is applied to a partial region of the base material 101 by selective irradiation with the laser. That is, by irradiating a limited region with the laser, the silanol group of the coupling agent molecules 202 adsorbed in the limited region (in a case where the coupling agent molecules 202 are the silane coupling agent) reacts with the surface of the base material 101 to form the covalent bond in the limited region, so that the portion of the coupling agent molecules 202 irradiated with the laser (the limited region) is firmly immobilized to the base material 101.

As the laser to be radiated to the coupling agent solution 201 on the base material 101, that is, the adsorbed coupling agent molecules 202, a pulse laser is preferable as in the above embodiment. When the energy irradiation is performed using the pulse laser P, the damage due to the heat of the irradiated portion is suppressed, so that the deterioration, the change in quality, and the breakage of the adsorbed coupling agent molecules 202 can be prevented.

Further, as in the above-described embodiment, it is preferable that the pulse width of the pulse laser P is as short as possible in order to suppress the influence of heat. To be more specific, it is preferable that the pulse width is 10 ns or less. Further, 1 ps (picosecond) or 1 fs (femtosecond) is more preferable. On the other hand, as the pulse width is smaller, the facility cost becomes much higher, therefore, considering the producibility, it is preferable to use a pulse width on the order of 10 ns.

As in the above-described embodiment, the wavelength of the pulse laser is not particularly limited, but is preferably in the range of, for example, 200 to 1500 nm, and more preferably in the range of 400 to 1000 nm. The average power of the pulse laser is also not particularly limited, but is preferably about 0.1 to 100 W, and more preferably about 1 to 25 W. When the output is higher than this range, damage to the base material is concerned.

In addition, the energy density (J/cm²) of the pulse laser P to be radiated per unit area is preferably in the range of 0.5 to 20 J/cm². Further, the range of 1 to 10 J/cm² is more preferable. In the case of less than 0.5 J/cm², the amount of energy to be supplied is small, so that the adsorbed coupling agent molecules 202 cannot react with the substrate 101. On the other hand, in a case of 20 J/cm² or more, the energy to be supplied is excessive, so that the adsorbed coupling agent molecules 202 themselves are deteriorated, changed in quality, or damaged. These are the same as those in the above-described embodiment.

Next, in FIG. 6(d), the unreacted and adsorbed coupling agent molecules 202 in the laser non-irradiated portion on the base material 101 are removed. The removal method is not particularly limited, and a method such as cleaning with running water or ultrasonic cleaning is used. In addition, at this time, in the binding layer 203 irradiated with the pulse laser, the coupling agent molecules 202 that were excessively adsorbed in an overlapping manner and have not reacted with the base material 101 can also be removed at the same time.

Next, in FIG. 6 (e), coating with a coupling agent solution 211 which is different from the coupling agent solution 201 is performed. At this time, the portion to be coated is not particularly limited, and the coating may be performed mainly on a region (portion) other than the previously bonded portion 203 or may be performed on the entire surface of the base material 101. The method of coating with the coupling agent solution 201 to the substrate 101 is not particularly limited, and examples thereof include a dipping method, a spin coating method, a bar coating method, a spray coating method, and a screen printing method. This is the same as the coating method described above.

After the above-described coating in FIG. 6(f), the adsorbed coupling agent molecules 212 are immobilized by radiating the pulse laser P to a region (portion) to be bonded to the base material 101. The pulse laser P to be radiated is the same as that in FIG. 6(c) described above.

After the laser irradiation, in FIG. 6(g), the unreacted and adsorbed coupling agent molecules 212 are removed, and the resin 301 is bonded in the same manner as in Embodiment 1, so that the base material 101 and the resin 301 can be strongly bonded.

As described above, by immobilizing the coupling agent by the pulse laser irradiation, different coupling agents can be bonded to the central portion and the outer peripheral portion of the bonded body.

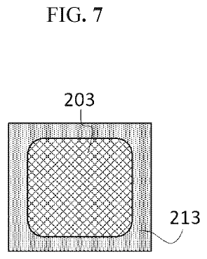

Regarding regions on the base material 101 to be divided into, various ways are conceivable. For example, FIG. 7 is a diagram showing a state in which the binding layers 203 and 213 are formed by the irradiation of the pulse laser P in the process shown in FIG. 6(f), which is viewed from the laser irradiation side. Note that FIG. 7 can be seen as a cross section of the binding layers 203 and 213 of FIG. 6(g) cut along a plane perpendicular to the paper sheet.

In FIG. 7, the region of the binding layer 213 formed by the second laser irradiation process surrounds the outside of the region of the binding layer 203 formed by the first laser irradiation process. The characteristics of the respective binding layers 203 and 213 are different because the types of the coupling agent solutions 201 and 211 for the coating are different and the types of the adsorbed coupling agent molecules 202 and 212 are different.

For example, about the elastic moduli of the binding layers 203 and 213, the coupling agent solutions 201 and 211 can be selected such that the elastic modulus of the binding layer 213 disposed in the outer peripheral region is lower than the elastic modulus of the binding layer 203 disposed in the inner peripheral region. Then, the elastic modulus of the binding layer 213 in the outer peripheral region can be configured to be lower than that of the binding layer 203 in the inner peripheral region.

In general, in the outer periphery of the bonded body, the stress concentration coefficient is large and the stress is easily generated, therefore, by forming the bonding layer having a low elastic modulus of the outer periphery as described above, the stress can be relaxed while the bonding performance is maintained. That is, a bonded body in which the stress is relaxed can be provided, and the long-term reliability thereof can be improved. Conversely, the elastic modulus of the binding layer 213 in the outer peripheral region may be formed to be higher than that of the binding layer 203 in the inner peripheral region. In this way, because the elastic modulus of the outer periphery where the stress is generated is high, a bonded body (product) in which the dimensional change is suppressed even when the stress is generated can be obtained.

As for candidates for different characteristics, in addition to the elastic modulus, the linear expansion coefficient and the thermal conductivity may be varied according to a region. For example, by using coupling agent molecules having a different linear expansion coefficient, it is possible to control (regulate) the deformation direction of the bonded body during heating, or by using coupling agent molecules having different thermal conductivity, it is possible to obtain a bonded body having an efficient discharge performance of the heat from the heating element. In addition, in the first laser irradiation process of FIG. 6(c), the pulse laser is separately radiated to multiple regions, and in the second laser irradiation process of FIG. 6(f), the pulse laser is radiated to the other remaining regions, so that the bonding layers having different characteristics can be formed in the multiple regions.

In addition, while an example of the two divided regions has been described above, the region may be divided into two or more regions, or the multiple regions may have inclusion relationships.

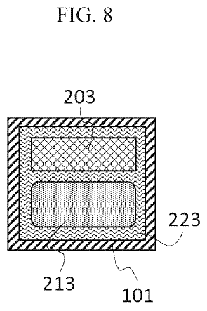

FIG. 8 is a diagram showing an example in which the region is divided into three or more regions viewed from the laser irradiation side. In this example, an upper central binding layer 203 is formed in the first laser irradiation process, a lower central binding layer 213 is formed in the second laser irradiation process, and a binding layer 223, which is a remaining region surrounding the binding layers 203 and 213, is formed in the third laser irradiation process. The binding layers 203, 213, and 223 may be formed to have different characteristics, or two of the binding layers may be formed to have different characteristics.

In order to manufacture the bonded body in the above-described configuration, in addition to the process shown in FIG. 6(f), a third coating process of coating with a different type of coupling agent solution 221, and a third laser irradiation process in which the pulse laser is radiated to coupling agent molecules 222 existing in a different region after the third coating process are provided, and then the bonding process shown in FIG. 6(g) is performed.

For example, in the configuration shown in FIG. 8, the elastic modulus of the binding layer 223 in the outer peripheral region may be set to be lower than the elastic moduli of the binding layers 203 and 213 in the inner regions, and the thermal conductivity of the binding layer 203 in the inner region of one side may be set to be higher than the thermal conductivity of the binding layer 213 in the inner region of the other side.

In the example shown in FIG. 8, in a case where a heating element that generates a larger amount of heat than other regions (for example, the region of the binding layer 213) exists on the surface opposite to the surface on which the binding layer of the base material 101 is disposed in the region of the bonding layer 203 disposed in the upper central portion, the heat discharge effect is increased, which is effective for improving the cooling performance in addition to the stress relaxation described above. In addition, since the thermal stress is considered to be small, the long-term reliability is further improved.

Further, a region may be arranged so as to surround another region.

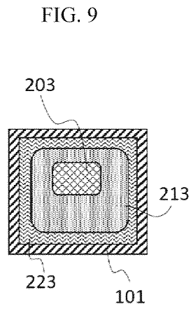

FIG. 9 is a diagram showing an example in which a region is arranged so as to surround another region, viewed from the laser irradiation side. In this example, a central binding layer 203 is formed in the first laser irradiation process, the binding layer 213 is formed in a region surrounding the binding layer 203 in the second laser irradiation process, and further, the binding layer 223 is formed in a region surrounding the binding layer 213 in the third laser irradiation process. The binding layers 203, 213, and 223 may be formed to have different characteristics, or two of the binding layers may be formed to have different characteristics.

For example, in the configuration shown in FIG. 9, the elastic modulus of the binding layer 223 in the outer peripheral region may be set to be lower than the elastic moduli of the binding layers 203 and 213 in the inner regions, and further the thermal conductivity of the binding layer 203 in the central region may be set to be higher than the thermal conductivity of the binding layer 213 in the other inner region.

In the example shown in FIG. 9, in a case where a heating element that generates a larger amount of heat than other regions (for example, the region of the binding layer 203) exists on the surface opposite to the surface on which the binding layer of the base material 101 is disposed in the region of the binding layer 203 disposed in the upper central portion, the heat discharge effect is increased, which is effective.

According to the present embodiment, the base material 101 is divided into regions, and coating with different types of the coupling agent solutions 201 and 211 is performed on the different regions, and then the respective regions are separately irradiated with the laser, so that the binding layers having different characteristics depending on the regions on the base material 101 can be formed to constitute the bonded body of different materials. Therefore, a more appropriate device can be configured by forming binding layers having appropriate characteristics in multiple regions in accordance with the positions of semiconductors provided on the base material 101 and the temperature characteristics thereof.

In addition, according to the present embodiment, since the elastic modulus of the binding layer 213 formed in the outer peripheral region is set to be lower than the elastic modulus of the binding layer 203 formed in the inner peripheral region, the bonded body of different materials in which stress is relaxed can be formed, so that long-term reliability can be improved.

In addition, according to the present embodiment, by forming the binding layer having a higher thermal conductivity in a region where the heating element is disposed on the surface of the base material 101 opposite to the surface on which the binding layers 203 and 213 are formed, it is possible to form the bonded body of different materials having high heat discharge efficiency. With this structure, the thermal stress can be reduced.

### DESCRIPTION OF REFERENCE NUMERALS AND SIGNS

101: base material
201,211,221: coupling agent solution (silane coupling agent solution)
202,212,222: coupling agent molecules (silane coupling agent molecules)
203,213,223: binding layer
301: resin

1. A manufacturing method for a bonded body of different materials, comprising:
a coating process of coating a surface of an inorganic base material including metal or glass with a coupling agent solution:
an irradiation process of forming a binding layer in which the base material and coupling agent molecules in the coupling agent solution are bonded through covalent bond by irradiating a surface of the base material coated with the coupling agent solution with a laser while a position of the laser is sequentially changed:
a cleaning process of cleaning the coupling agent solution that is not covalently bonded to the base material; and
a resin bonding process of bonding the binding layer and a resin.

2. The manufacturing method for the bonded body of different materials according to claim 1, wherein the coupling agent solution is an amino-based silane coupling agent solution.

3. The manufacturing method for the bonded body of different materials according to claim 1, wherein the laser is a pulse laser and has an irradiation energy density in a range from 1 J/cm² to 10 J/cm².

4. The manufacturing method for the bonded body of different materials according to claim 1, wherein
the coating process includes a first coating process of coating with a first coupling agent solution,
the irradiation process includes a first irradiation process of irradiating a partial region of the surface of the base material with the laser after the first coating process,
the cleaning process includes a first cleaning process of cleaning, after the first irradiation process, the first coupling agent solution that is not bonded to the base material,
the coating process includes, after the first cleaning process, a second coating process of coating with a second coupling agent solution of a type different from that of the first coupling agent solution, and
the irradiation process includes a second irradiation process of irradiating, after the second coating process, a region of the surface of the base material with the laser, the region being different from the partial region of the surface of the base material irradiated in the first irradiation process.

5. The manufacturing method for the bonded body of different materials according to claim 4, wherein the region to be irradiated with the laser in the first irradiation process is outside the region on the surface of the base material to be irradiated with the laser in the second irradiation process.

6. The manufacturing method for the bonded body of different materials according to claim 5, wherein an elastic modulus of the binding layer formed in the first irradiation process is lower than an elastic modulus of the binding layer formed in the second irradiation process.

7. The manufacturing method for the bonded body of different materials according to claim 4, wherein the region to be irradiated with the laser in the first irradiation process is an inner side of the region on the surface of the base material to be irradiated with the laser in the second irradiation process.

8. A bonded body of different materials, comprising:
an inorganic base material including metal or glass:
a bonding layer having a pulse laser irradiation mark in a binding layer in which a surface of the base material and coupling agent molecules are covalently bonded; and
a resin bonded to a surface of the bonding layer opposite to the surface thereof covalently bonded to the base material.

9. The bonded body of different materials according to claim 8, wherein the bonding layer has continuous laser irradiation marks.

10. The bonded body of different materials according to claim 8, wherein
the bonding layer includes a first binding layer in which a first coupling agent is covalently bonded to a surface of the base material, and has a first region in which the first binding layer is provided on the base material and a second region in which a second binding layer is provided on the base material, the second binding layer being a layer in which a second coupling agent different from the first coupling agent is covalently bonded to the surface of the base material.

11. The bonded body of different materials according to claim 10, wherein the first region is provided outside the second region on the surface of the base material.

12. The bonded body of different materials according to claim 10, wherein an elastic modulus of the first binding layer is different from an elastic modulus of the second binding layer.

13. The bonded body of different materials according to claim 11, wherein an elastic modulus of the first binding layer is smaller than an elastic modulus of the second binding layer.
